(19) United States
(12) Patent Application Publication
(10) Pub. No.: US 2005/0086839 A1
(43) Pub. Date: Apr. 28, 2005

(54) Hanging picture gallery or album

(76) Inventors: John W. Barfield, Ann Arbor, MI (US); Brian O. Robinson, Ypsilanti, MI (US)

Correspondence Address: James M. Deimen, Suite 300, 320 North Main Street, Ann Arbor, MI, 48104-1192, US

(21) Appl. No.: 10/478,931

(22) PCT Filed: Jun. 4, 2002
(86) PCT No.: PCT/US02/17544

Related U.S. Application Data
(60) Provisional application No. 60/295,657, filed on Jun. 4, 2001.

(51) Int. Cl. G09F 1/10

(52) U.S. Cl. 40/124.2; 40/757

(57) ABSTRACT

A hanging picture gallery or album comprises a plurality of relatively large plastic sheets, each formed with a large number of pockets adapted to retain individual photographs. In the preferred embodiment, the pockets are formed on both sides of each sheet, and the plastic sheets are vertically retained on a special multiple hook support in turn adapted to hang from the top of a door. The number of plastic sheets is limited only by the size of the hooks on the special multiple hook support. Ten to fifty sheets may be accommodated on a special multiple hook support without unduly stressing a solid properly hung door. Each sheet may have twenty to fifty pockets for photographs on each side, all on one side viewable at the same time. In the preferred embodiment, the sheets are slightly less than 30″ wide to conveniently be hung from the hooks on the back side of a closet door or bedroom door. Several optional configurations of the special multiple hook support are disclosed for doors of different thickness and for manually carrying the gallery or album.

### BACKGROUND OF THE INVENTION

This application claims the benefit of provisional patent application No. 60/295,657, filed Jun. 4, 2001.

The field of the invention pertains to picture albums for protecting, organizing and displaying large numbers of small photographs. Such albums are typically in the form of large books with multiple pages, each sized to retain four to twelve pictures, depending upon picture size and page size. The pages may be of strong paper with the photographs glued thereto, or the pages may be of plastic with pockets to retain the photographs.

While the albums may be adequate for protecting the photographs, albums suffer certain deficiencies in displaying and organizing the photographs. For example, photographs may only be organized and displayed page by page, with only those on a specific page viewable at one time. In some albums, the back side of pages are used to display photographs, doubling the viewable display, but often resulting in damaged photographs as the pages are opened and closed.

With a view toward overcoming the deficiencies of albums and allowing a much larger organization and display space, the following hanging picture album has been developed.

### SUMMARY OF THE INVENTION

The new hanging picture album comprises a plurality of plastic sheets, each formed with a large number of pockets adapted to retain individual photographs. The pockets may be on one or both sides of each sheet. In the preferred embodiment, the plastic sheets are vertically retained on a special multiple hook support in turn adapted to hang from the top of a door. The number of plastic sheets is limited only by the size of the hooks on the special multiple hook support. Ten to fifty sheets may be accommodated on a special multiple hook support without unduly stressing a solid properly hung door.

Typically, fewer than ten sheets will be employed because each sheet may have twenty to fifty pockets for photographs, all viewable at the same time. In the preferred embodiment, the sheets are less than 30″ wide to conveniently be hung on the back side of a closet door or bedroom door. As an option, an opaque dust cover may be hung from the hooks to cover the vertical stack of plastic sheets and thereby protect against light damage to the photographs.

Although the hanging picture album disclosed below is directed to displaying photographs, other thin items, such as text notes and identifying information, may be placed in some of the pockets as can diskettes and other computer related items, for example.

### BRIEF DESCRIPTION OF THE DRAWINGS

FIG. 1 is an exploded perspective view of a single sheet, multiple hook support and door;

FIG. 2 illustrates the single sheet and multiple hook support on the door;

FIG. 3 illustrates in exploded view an adaptation for hanging a single sheet on a closet hanger;

FIG. 4 illustrates the single sheet on the closet hanger;

FIG. 5 illustrates a further adaptation for hanging a single sheet on a café rod;

FIG. 6 illustrates in cutaway view a single sheet and dust cover;

FIGS. 7A and 7B illustrate pocket inserts for smaller photographs or other items;

FIG. 8 illustrates insertion of a pocket insert;

FIG. 9 illustrates the folding and packaging of a single sheet for convenient carrying of one or more sheets;

FIG. 10 is a perspective view of a convertible multiple hook support;

FIG. 11 illustrates the conversion of the multiple hook support;

FIG. 12 is a perspective view of the converted multiple hook support;

FIGS. 13A and 13B illustrate the conversion of the multiple hook support for two different door thicknesses;

FIG. 14 illustrates in perspective the preferred twenty pocket sheet;

FIG. 15 is a partial cutaway of the twenty pocket sheet rotated 900;

FIG. 16 illustrates an alternative form of the support and hanging sheets;

FIG. 17 is an end view of the support of FIG. 16 with U-hooks raised;

FIG. 18 is an end view of the support of FIG. 16 with U-hooks lowered;

FIG. 19 illustrates an alternative form of the support of FIG. 16;

FIG. 20 is an end view of the support of FIG. 19 with the U-hooks raised;

FIG. 21 is a separate perspective view of the rod of FIG. 19 that holds a sheet;

FIG. 22 illustrates a hanging cover suitable for the hanging sheets in FIG. 16 or 19;

FIG. 23 illustrates an integral sheet metal form of the support;

FIG. 24 illustrates a shorter version of the support of FIG. 23;

FIG. 25 is an end view of the supports of FIGS. 23 and 24;

FIG. 26 illustrates in perspective view a wheeled cart for transporting a large number of the sheets suitable for the supports of FIG. 23 or FIG. 24;

FIG. 27 illustrates a document organizer hanging sheet;

FIG. 28 illustrates folding of a large sheet into a compact form;

FIG. 29 illustrates a carrying case for the folded sheet; and

FIG. 30 illustrates a second form of carrying case.

### DESCRIPTION OF THE PREFERRED EMBODIMENTS

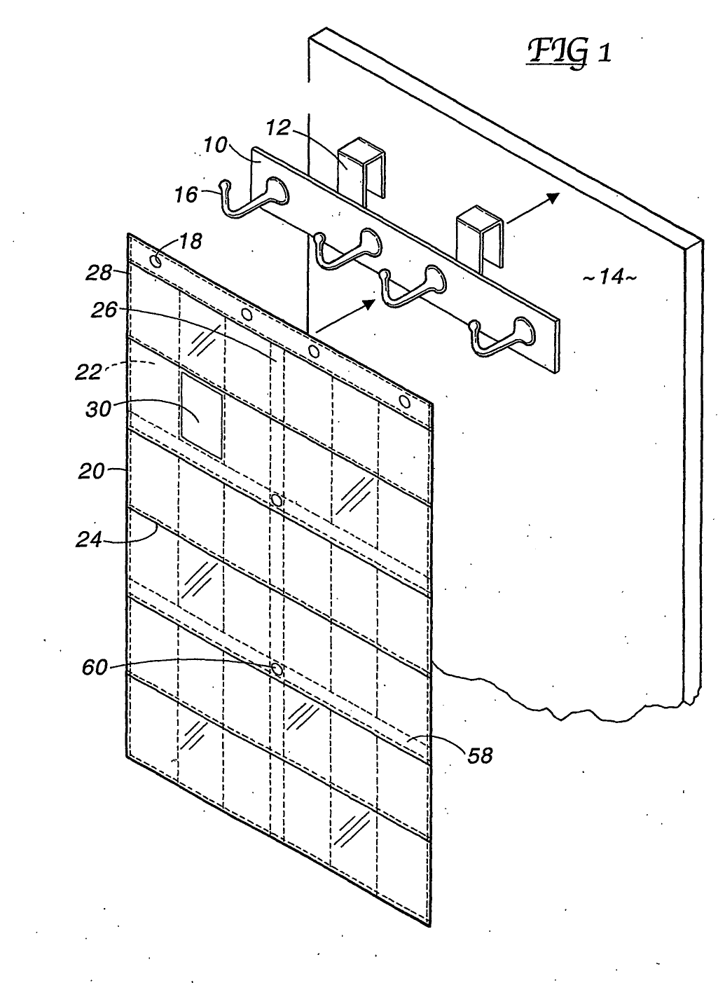

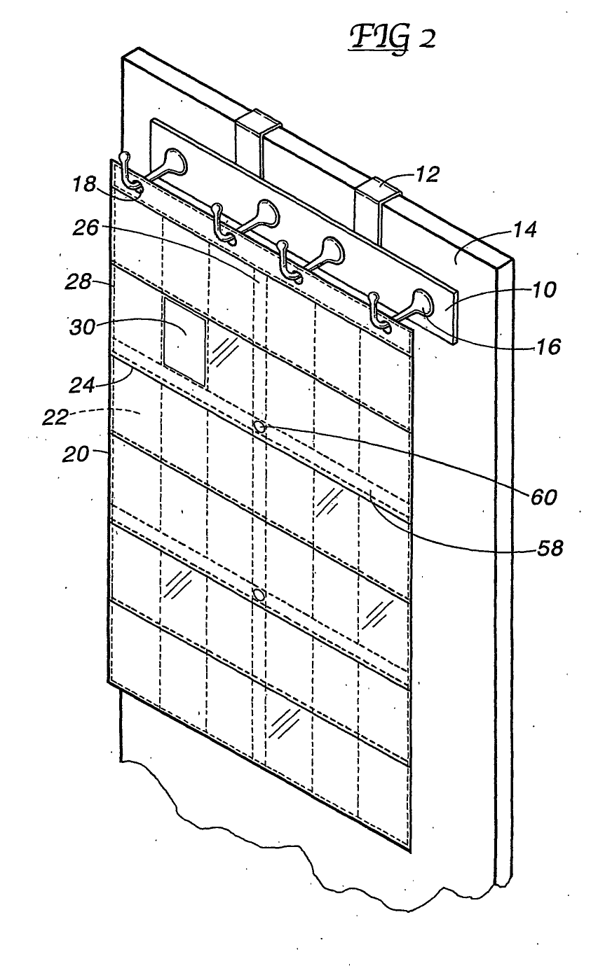

In FIGS. 1 and 2, a special support 10 with U-hooks 12 fits the top of a door 14 and has a plurality of L-hooks 16 extending therefrom. The L-hooks 16 are spaced to accommodate the holes 18 in the top of a plastic sheet 20 whereby the plastic sheet can freely hang from the L-hooks.

Sheet 20 is formed with a plurality of pockets delineated by dashed lines 22, the pocket openings being delineated by solid lines 24. Assuming 4″ by 6″ photograph pockets in the vertical format shown, the width overall, including center space 26 and borders 28, is well within 30″, and the length is within 44″. Such a size is well suited for the back of a standard closet door. Up to 36 pictures 30 can be displayed and viewed in an attractive format. The sheet 20 can be easily removed from the L-hooks 16 to be laid out on a table or for other purposes. With pockets 22 on both sides, a single sheet 20 can accommodate up to 72 photographs. With multiple sheets 20, a vast quantity of photographs can be displayed in an organized and easily viewable manner.

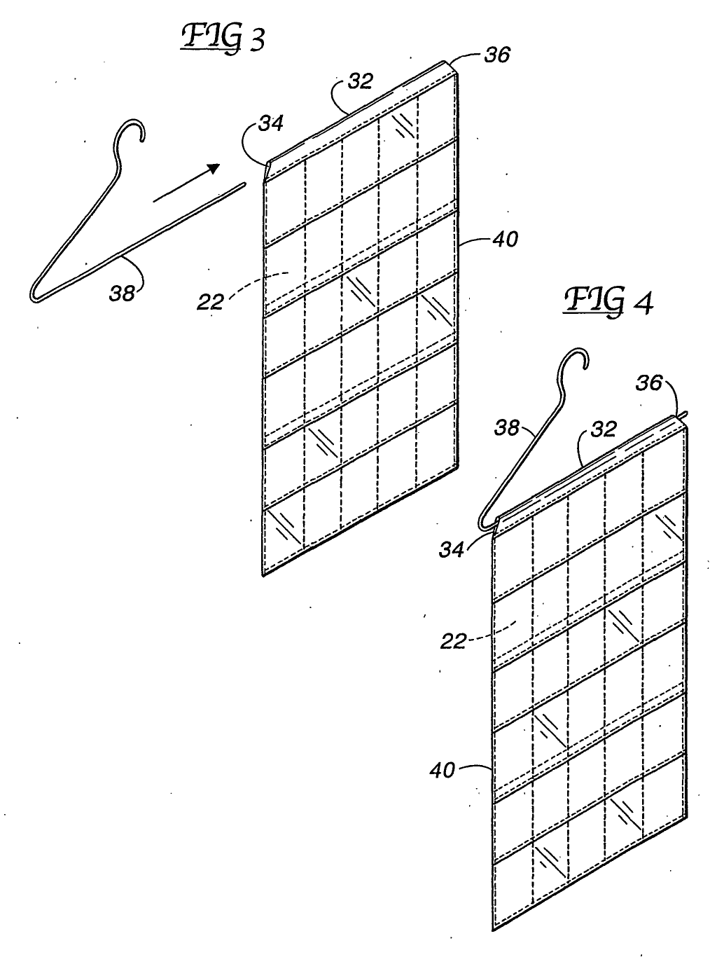

In FIGS. 3 and 4, a pocket 22 sheet 40 is illustrated with the top 32 of the sheet formed into a horizontal tube 34 having one or both ends 36 thereof open. Insertable therein is a modified sturdy clothes hanger 38 to support the sheet 40 on a typical closet rod. Depending on the number of sheets 40 utilized, a vast quantity of photographs can be stored but nevertheless be easily retrievable for display on a single hook vertically or table top horizontally.

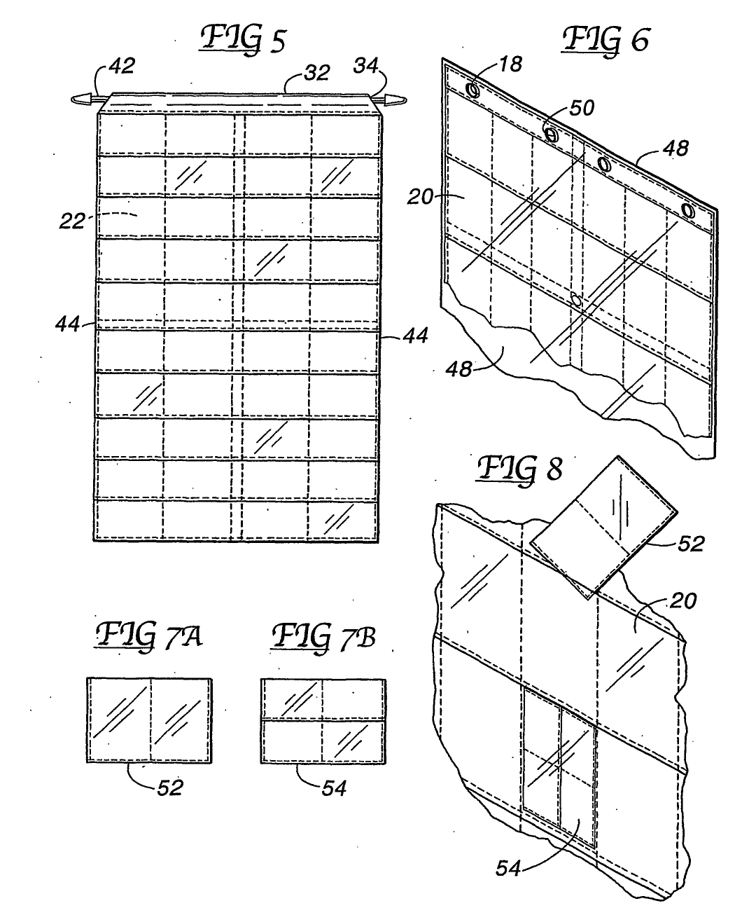

As shown in FIG. 5, the horizontal tube 34 at the top 32 can accommodate a café rod 42 for display of a single sheet 44 as a wall hanging. The sheet 44 has forty pockets 22 arranged in horizontal format. Assuming pockets to accommodate 4″ by 6″ photographs, the sheet 44 provides a width of about 28″ and length of about 46″ overall for an attractive display of photographs in an office or home setting.

Returning to the basic format of FIG. 1, FIG. 6 illustrates an opaque or clear protective dust and light cover 48, including holes 50 to match the holes 18 in the plastic sheet 20. The opaque or clear cover 48 can also be used to cover the wall hanging embodiment of FIG. 5 with suitable modification at the top of the cover.

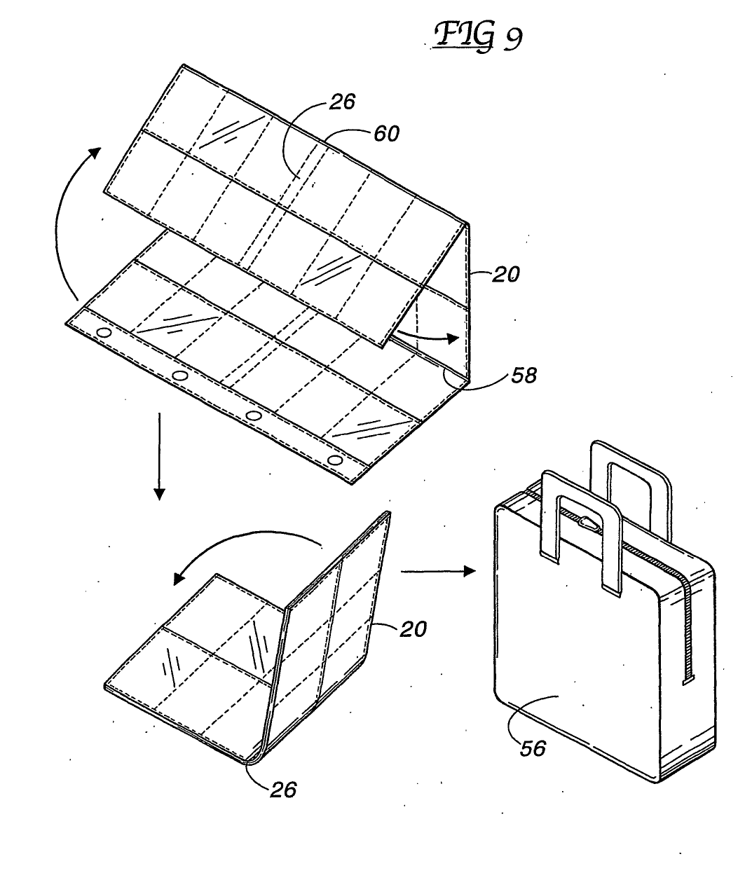

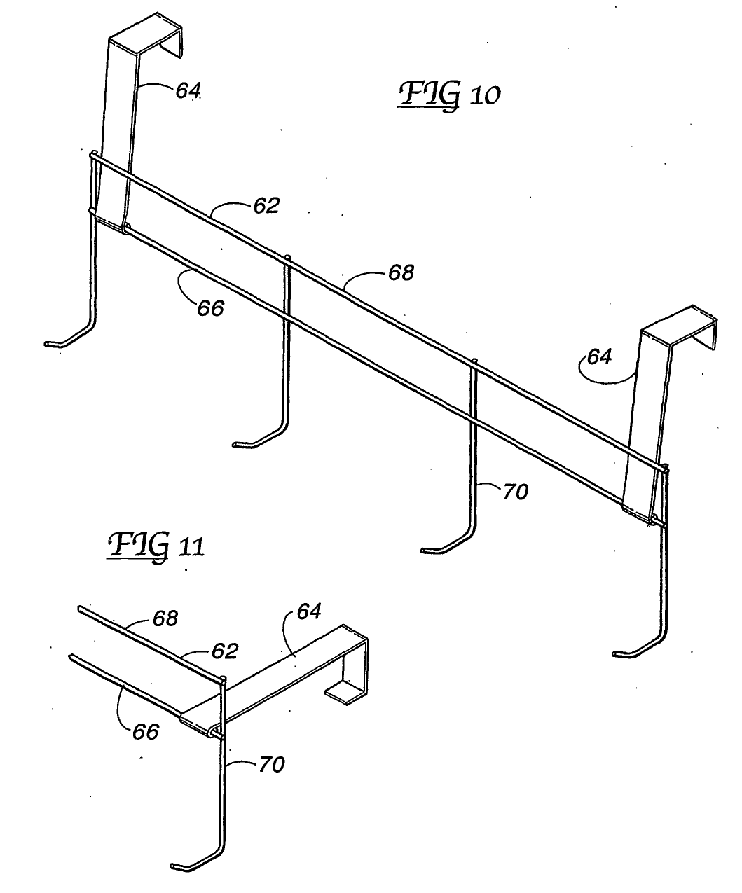

In FIGS. 7A, 7B and 8, pocket inserts 52 and 54 for smaller size photographs are illustrated. While a sheet 20 may be manufactured with two or four times as many pockets for the smaller pictures, such a configuration negates the possibility of mixing larger photographs with smaller photographs. The pocket inserts 52 and 54 also permit easier insertion and removal of smaller photographs in comparison with merely stuffing multiple small photographs into a single pocket. The pocket insert 52 or 54 may be opaque and serve as a convenient receptacle for negative strips, thereby enabling the negatives to be kept with the photographs and reducing the likelihood of misplacing the negatives. Text or titles may be printed on opaque pocket inserts.

With pocket insert 54 sized for wallet sized photographs, a significant portion, if not an entire graduation class, can be displayed in any arrangement desired. For young people and students, the ability to rearrange the format of display has great advantage over a single large format of tiny pictures or many pages of pictures in an album.

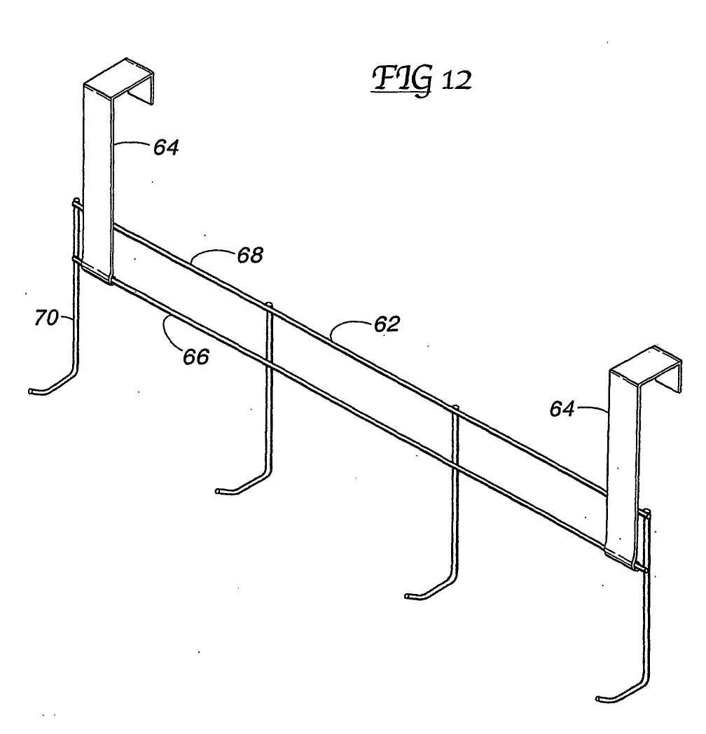

FIG. 9 illustrates the folding of the sheet 20 embodiment of FIG. 1 to accommodate a convenient carrying case 56. The vertical center space 26 and horizontal spaces 58 provide folding lines both horizontally and then vertically, as shown in sequence by arrows in FIG. 9. The holes 60, best shown in FIG. 1, prevent crinkling and other damage that might otherwise occur when the sheet 20 is folded. Depending on the internal thickness of the case 56, several filled sheets 20 may be folded and carried therein.

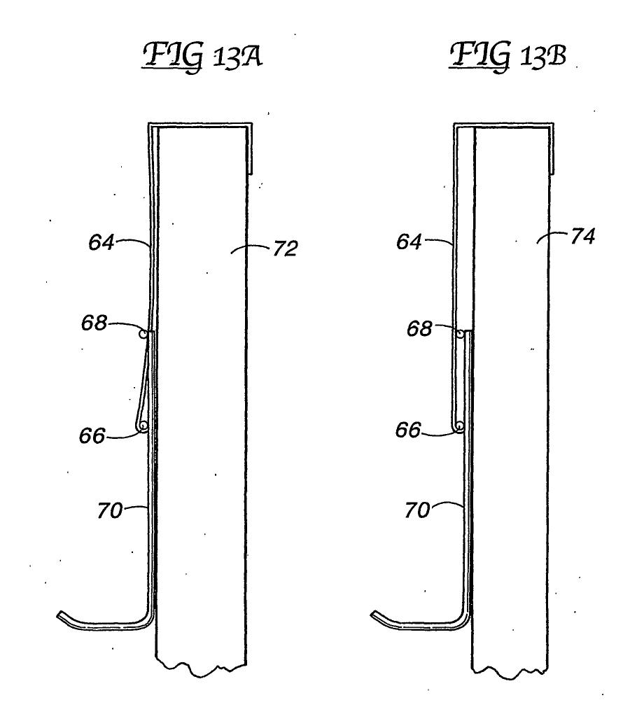

In FIGS. 10, 11 and 12, a convertible multiple hook support 62 is depicted. The over the door top U-hooks 64 are attached to the lower horizontal member 66 in a manner that permits the U-hooks to swivel as shown by the arrow in FIG. 11. The upper horizontal member 68 acts as a stop or limit to the swiveling of the U-hooks 64 from the position in FIG. 10 to the position shown in FIG. 12. The L-hooks 70 are rigidly fastened to the upper 68 and lower 66 horizontal members to complete the convertible multiple hook support 62. Thus, the U-hooks 64 may be behind the upper horizontal member 68 as shown in FIG. 10 or in front of the upper horizontal member 68 as shown in FIG. 12.

By swiveling the U-hooks 64, two different door thicknesses that are in common use can be accommodated as best shown in FIGS. 13A and 13B. In FIG. 13A, the door 72 thickness is relatively large, such as 1.75″, and the U-hooks 64 are positioned behind the upper horizontal member 68 as also shown in FIG. 10. In contrast, in FIG. 13B the door 74 thickness is less, such as 1.375″, and the U-hooks 64 are positioned in front of the upper horizontal member 68 as also shown in FIG. 12. By properly sizing the horizontal upper member 68, the U-hooks 64 and the L-hooks 70, a difference in two door thicknesses common in the United States can be accommodated to provide a good non-sloppy fit by the U-hooks to either door thickness.

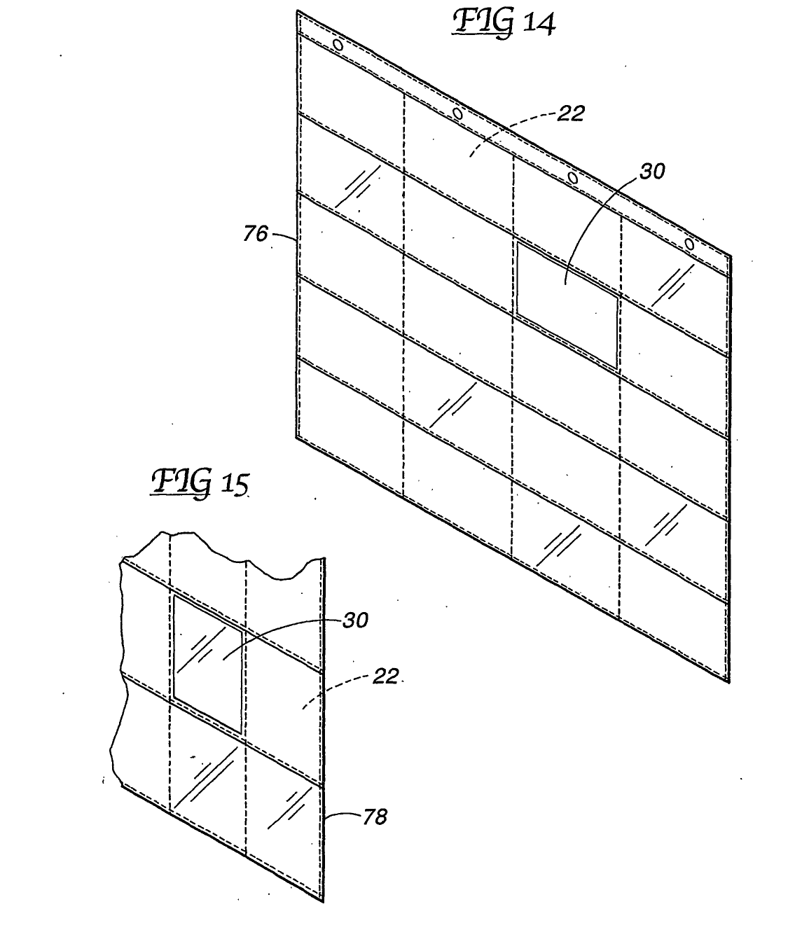

FIGS. 14 and 15 depict gallery sheets 76 and 78 for twenty photographs on a side. Sized for 5″ by 7″ photographs the horizontal orientation shown in FIG. 14 can nevertheless fit well within the 30″ standard door width. Using only twenty-five sheets on both sides a thousand photographs can be hung on the back side of a closet door in a very organized manner. FIG. 15 depicts the vertical format for a gallery sheet 78 wherein an additional column can be added within the closed door setting. Since the sheets are easily mounted on and removed from the hooks, any sheet can be easily retrieved for viewing.

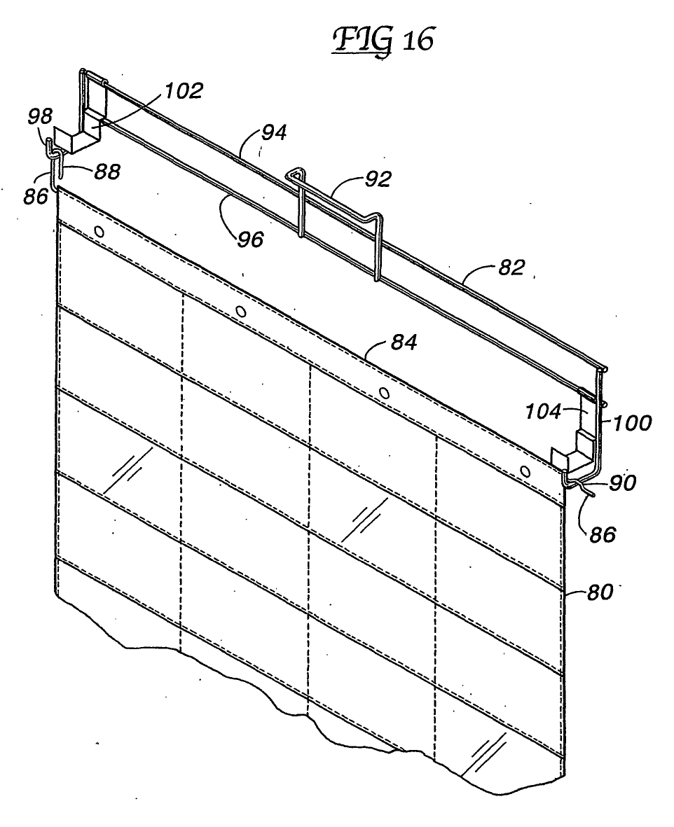

FIG. 16 depicts a modified gallery sheet 80 and hanger 82 that permits the removal or addition of sheets without the removal of any sheets thereover. The top 84 of the sheet 80 is formed with a tube similar to that shown in FIG. 3 to permit the insertion of a rod 86. The rod 86 is formed with a vertical hook 88 at one end and a notch 90 adjacent the other end.

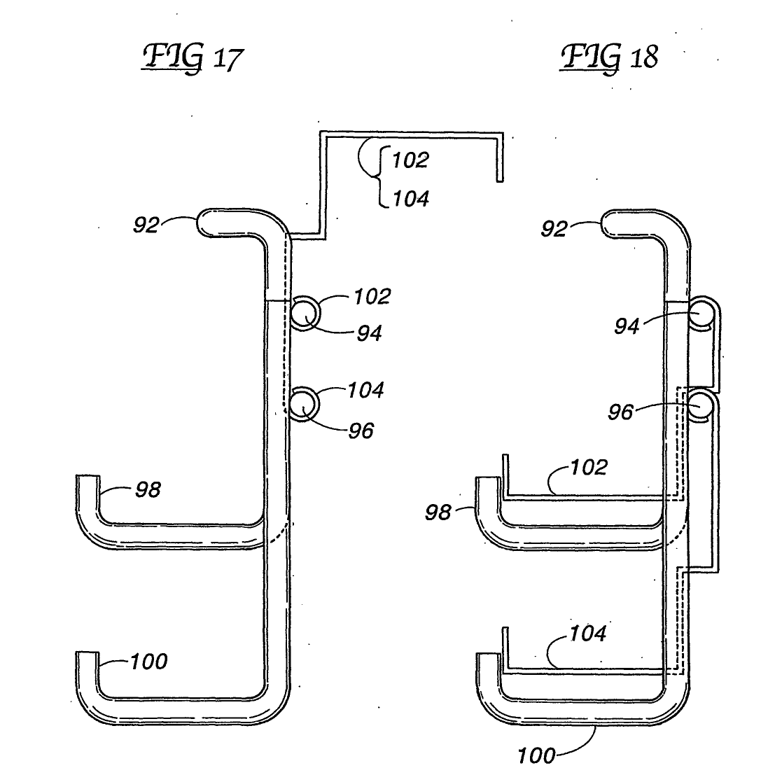

The modified support 82 has a grip 92 attached at the center of the horizontal rods 94 and 96. A J-hook 98 and a second J-hook 100 are attached at the ends of the rods 94 and 96. The J-hook 100 extends downwardly from the horizontal rods 94 and 96 somewhat more than the J-hook 98 to accommodate the difference in elevation of the top of the hook 88 from the notch 90. The over-the-top U-hooks 102 and 104 are crimped about rods 94 and 96, respectively, as also shown in FIGS. 17 and 18. In FIG. 17, the U-hooks 102 and 104 are in position to hook to the top of a door. In contrast, in FIGS. 16 and 18 the U-hooks are in position to prevent a plurality of sheets 80 and rods 86 from being jostled off the J-hooks 98 and 100 as the gallery or album is being carried by the grip 92.

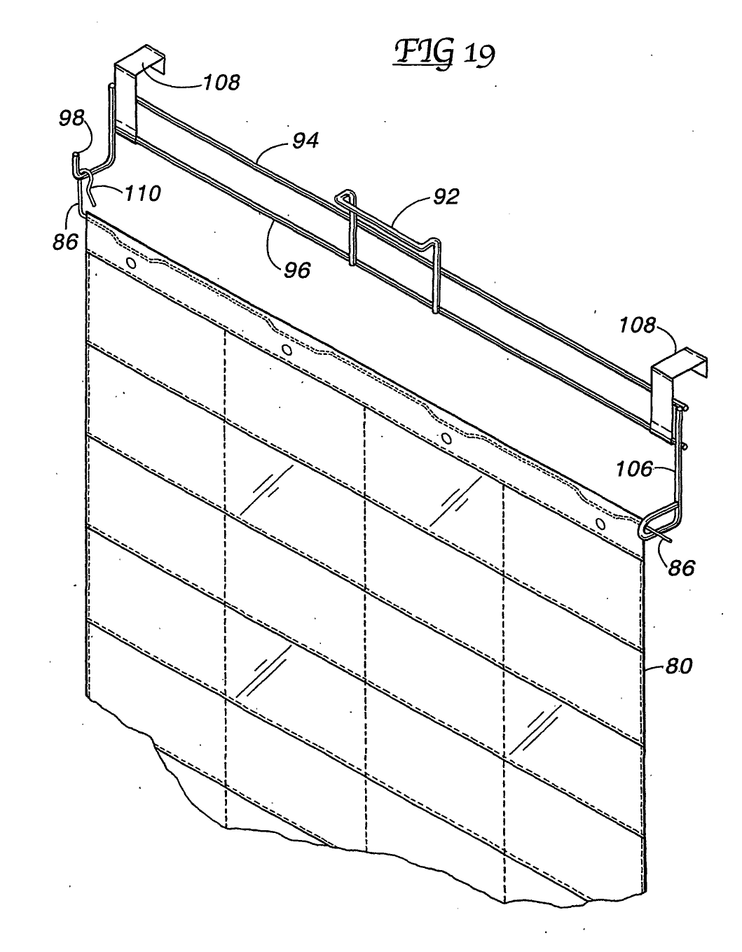

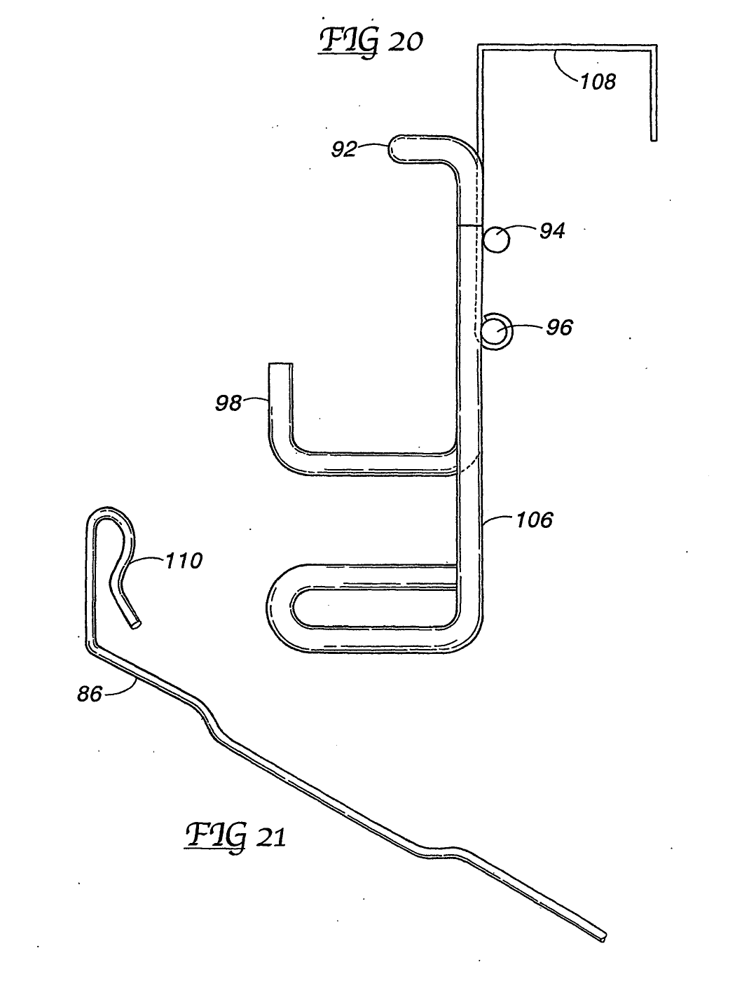

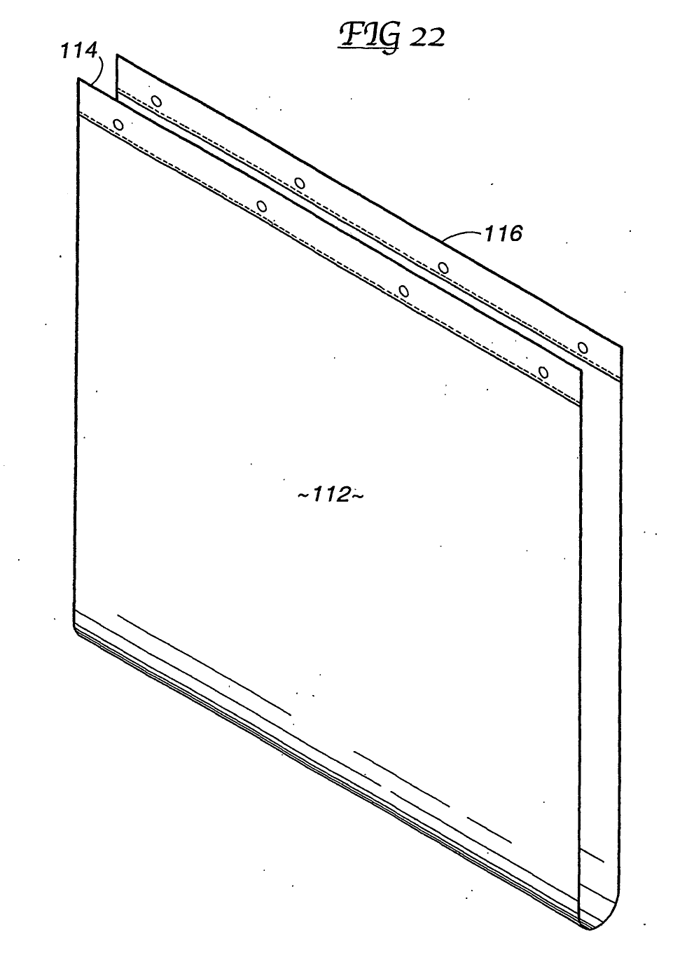

In FIG. 19, a further modification of the support 82 comprises an eye hook 106 downwardly extending from one end of the rods 94 and 96. A plurality of sheets 80 with rods 86 (one shown) are supported at the non-hook end of the rods 86 by the eye hook 106 which prevents the rods and sheets from being jostled loose from the support 82. In this version, the over-the-top U-hooks 108 are identical and rotate about the rod 96. The hook 110 on the rod 86 is formed as shown to snap over the J-hook 98. FIG. 20 depicts the support 82 of FIG. 19 from the eye hook 106 end with the U-hook 108 in position for attachment to a door, and FIG. 21 depicts the rod 86 with the snap-over hook 110.

Suitable for use to cover the hanging sheets 80 in FIGS. 16 and 19 is the hanging cover 112 of FIG. 22 formed with tubes 114 and 116 at the top for a pair of rods 86. Thus, with the support 82 having a grip 92, a thousand photographs on twenty-five sheets can be easily carried in a protective cover 112.

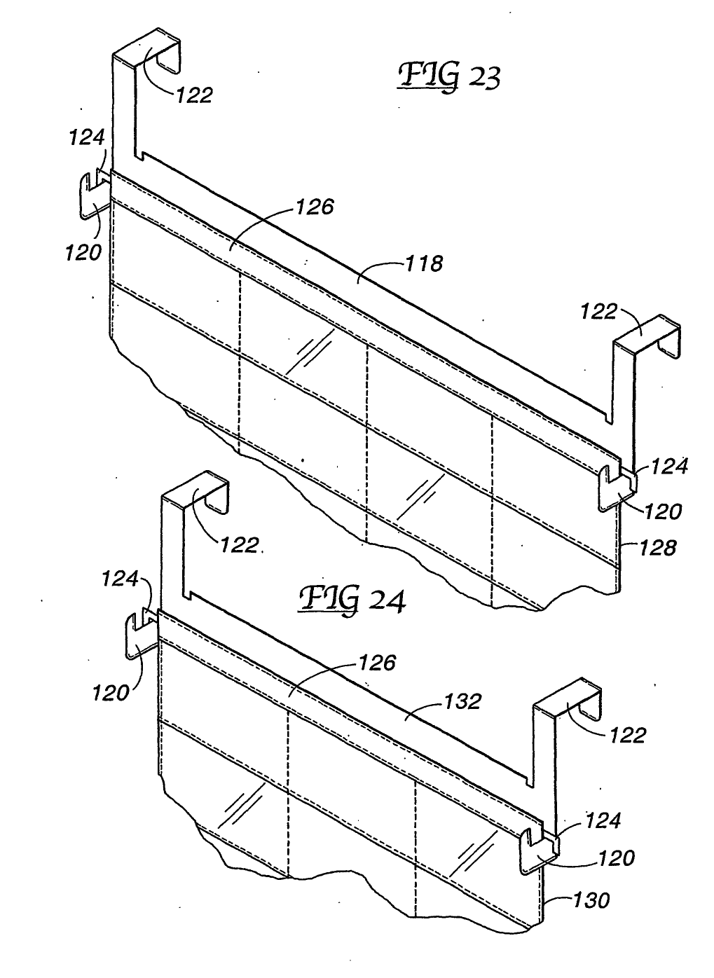

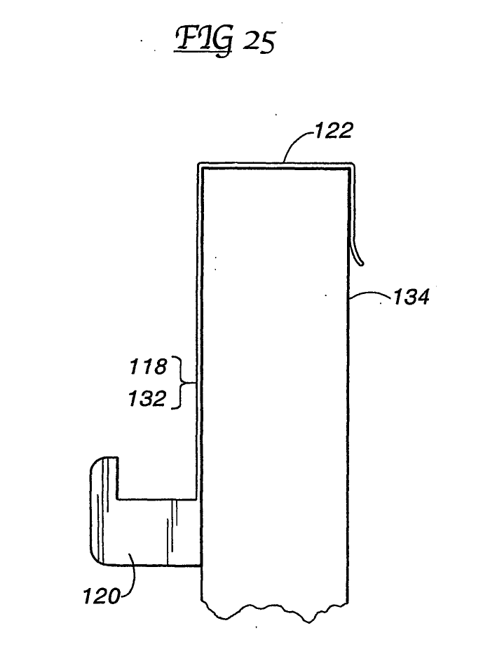

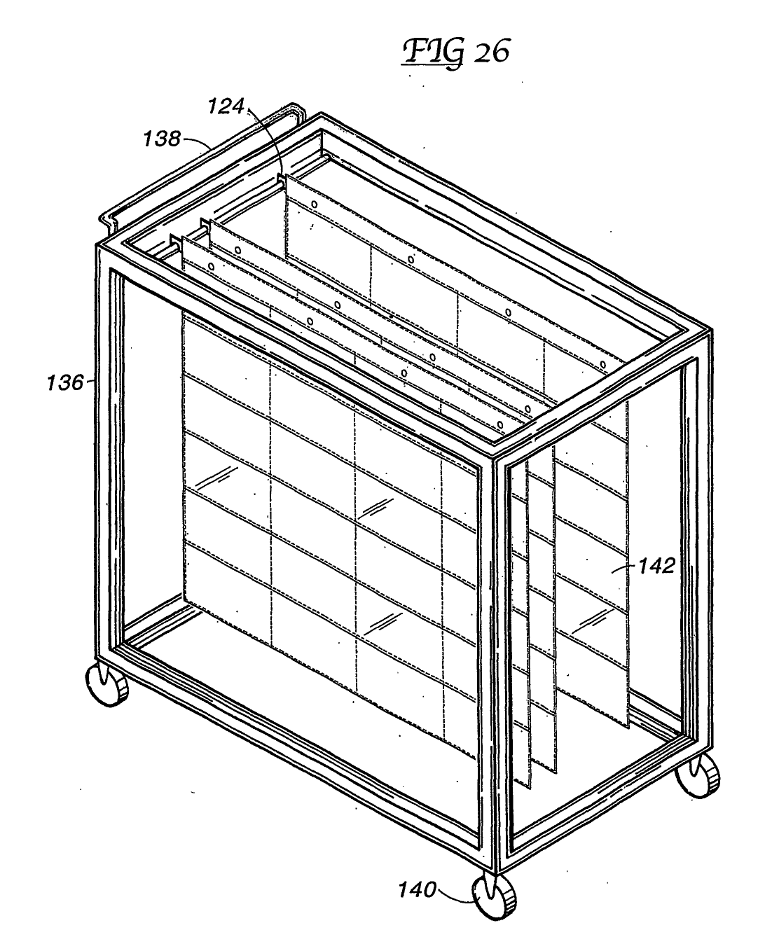

Illustrated in FIGS. 23, 24 and 25 is a sheet metal support 118 formed from one piece by punching and bending or stamping. At each end are integral J-hooks 120 and U-hooks 122. As before, the U-hooks 122 are sized to fit over a door. The J-hooks 120, however, are sized to support a plurality of flat rods with hooked ends 124 which in turn fit through tubes 126 at the top of hanging sheets 128 in a manner similar to hanging files. Two sizes are envisioned, one 128 in FIG. 23 with four pockets across and the other 130 in FIG. 24 with three pockets across on a shorter support 132. FIG. 25 depicts either support 118 or 132 installed on a door 134.

The wheeled cart of FIG. 26 which comprises a frame 136, handle 138 and four wheels 140 may be open sided as shown or include transparent or opaque side panels. An opaque or transparent top may also be provided. As shown, fifty or more sheets 142 suspended as shown in FIG. 23 or 24 by flat rods 124 may be positioned in the cart. Loaded with photographs in color and open or transparent, a striking display is created. With a support as shown in FIG. 23 or 24, individual sheets can be retrieved and hung on the support for viewing.

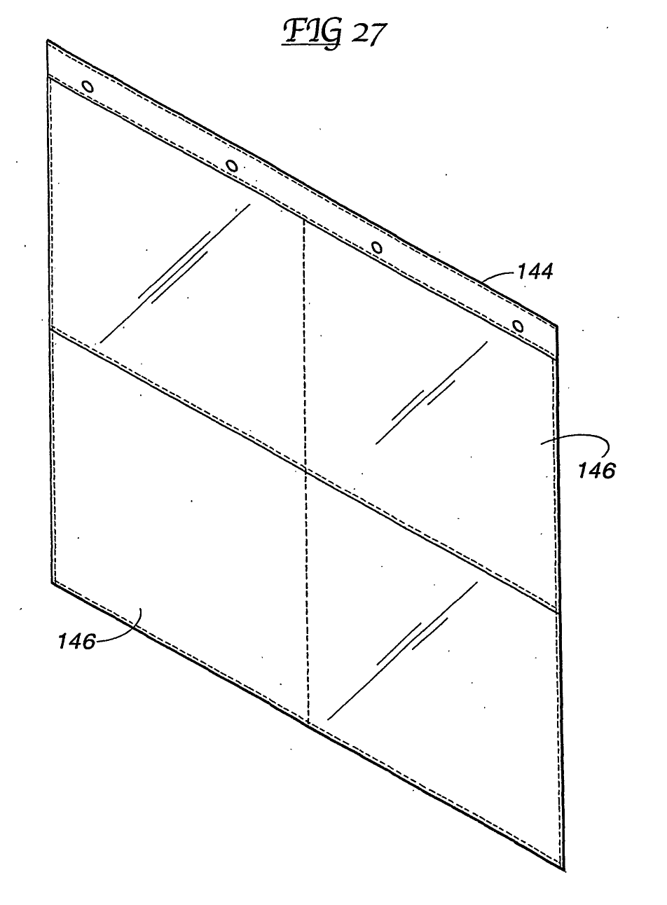

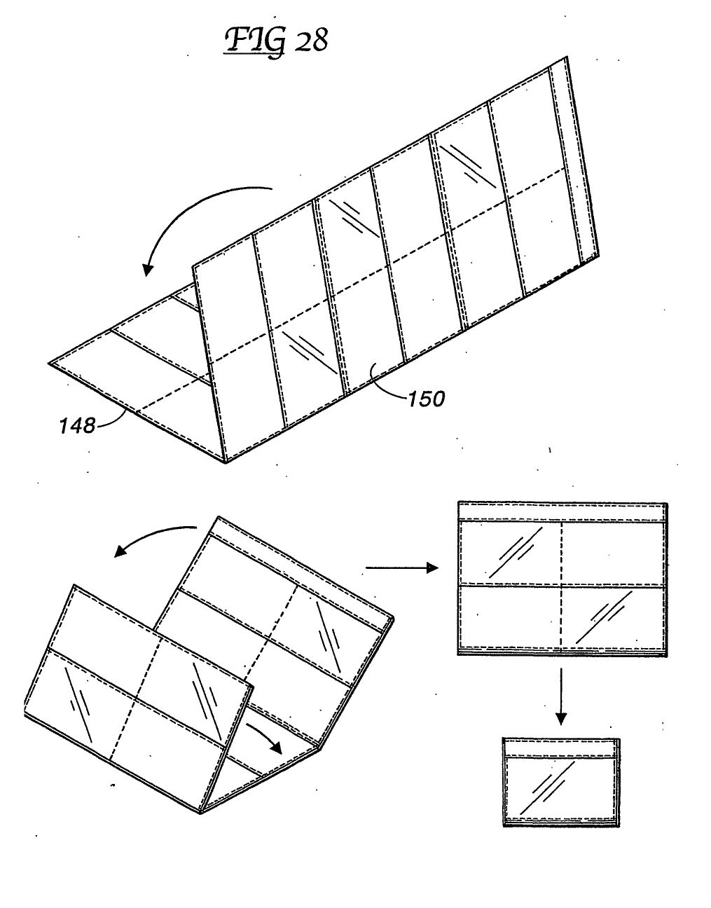

FIG. 27 illustrates a document organizer version of the hanging sheet 144 with four pockets 146 to a side. In addition to documents, very large photoprints can be displayed for presentations. The large pockets 146 also lend themselves to combinations of documents and computer discs or tapes, or folded sheets as depicted in the following FIG. 28.

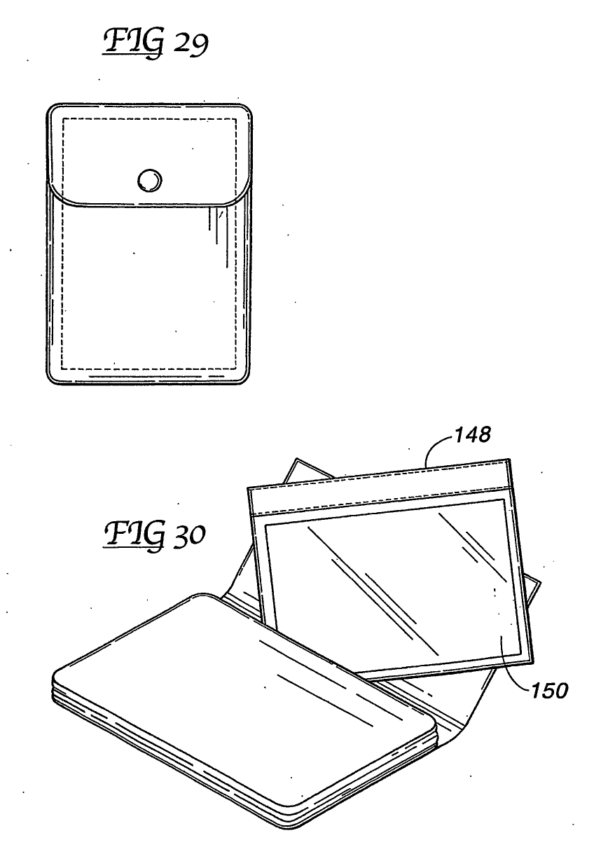

In FIG. 28, a twenty-four pocket sheet 148 is shown by arrows folded in four steps to a single pocket size, albeit of much greater thickness. Although not shown in FIG. 28, spaces 26 between panels and corner holes 60 as shown in FIG. 1 may be required depending upon the flexibility of the plastic chosen for the sheets and the thickness of any pictures in the pockets 150. Fully folded, the sheet of FIG. 28 can be fitted into a case such as shown in FIG. 29 or FIG. 30. Or a partially folded sheet can be placed in a pocket, such as noted above, with respect to FIG. 27.

1. A picture display album comprising a plurality of sheets each having a plurality of transparent pockets on at least one side of each sheet,
a support for the plurality of sheets adapted to vertically retain each sheet adjacent the top of each sheet,
means to vertically retain each sheet removably attaching each sheet to the support, and
means on the support to suspend the album with the plurality of sheets in vertical orientation.

2. The picture display album of claim 1 wherein the means on the support to suspend the album comprise U-hooks adapted to fit over the top of a door.

3. The picture display album of claim 2 wherein the U-hooks rotate on the support to adjust for differing door thicknesses.

4. The picture display album of claim 1, including a grip for carrying the album.

5. The picture display album of claim 1 wherein the means on the support to suspend the album are adjustable in effective size by rotation on the support.

6. The picture display album of claim 1 wherein the means to vertically retain each sheet include a tube formed in the top of each sheet and a rod insertable there through.

7. The picture display album of claim 6 wherein a hook extends from one end of the rod.

8. The picture display album of claim 7 wherein the support includes a plurality of J-hooks and the rod hook fits over one J-hook to attach a sheet to the support.

9. The picture display album of claim 8 wherein at least one J-hook comprises an eye hook to support the end of the rod remote from the rod hook.

10. The picture display album of claim 1, including at least one pocket insert for inserting a plurality of smaller pictures into a larger pocket.

11. The picture display album of claim 1, including spaces and holes in at least one sheet between at least some of the plurality of pockets to facilitate folding of the sheet.

12. The picture display album of claim 1 wherein the means on the support to suspend the album comprise U-hooks, said U-hooks rotatable on the support to retain the sheets from jostling loose from the support.

13. The picture display album of claim 1 wherein the support comprises a single piece, including integral means on the support to suspend the album and integral means to vertically retain the plurality of sheets.

14. The picture display album of claim 13, including a tube formed along the top of each sheet and a rod inserted through the tube, each end of each rod formed to fit on the integral means to vertically retain the plurality of sheets.
